(19) United States
(12) Patent Application Publication
(10) Pub. No.: US 2025/0306691 A1
(43) Pub. Date: Oct. 2, 2025

(54) APPARATUS, METHOD, AND PROCESSOR FOR MULTIZONE MOBILE ELECTRONIC DEVICE HOLDER KEYBOARD

(71) Applicant: Lenovo (Singapore) Pte. Ltd., New Tech Park (SG)

(72) Inventors: Brian William Wallace, Wake Forest, NC (US); Joel Collins, Raleigh, NC (US)

(21) Appl. No.: 18/622,799

(22) Filed: Mar. 29, 2024

(51) Int. Cl. G06F 3/02

(52) U.S. Cl. CPC G06F 3/0202

(57) ABSTRACT

Apparatuses, methods, and systems are disclosed for multizone mobile electronic device holder keyboard. One apparatus includes a keyboard, a first channel disposed along an upper portion of the keyboard, the first channel having a first width, and a second channel disposed along the upper portion of the keyboard, the second channel having a second width. The first and second channels are configured to hold a mobile electronic device at a set viewing angle. The first and second widths are distinct from one another. The apparatus may further include a third channel along the upper portion of the keyboard, the third channel having a third width. Where the third width is distinct from the first and second widths.

### FIELD

The subject matter disclosed herein relates to keyboards and the viewing angles of mobile electronic devices.

### BACKGROUND

### Description of the Related Art

Keyboards for computing devices, such as desktop computers, laptop computers, tablet computers, etc., are regularly used every day. Additionally, mobile devices, such as tablets and smartphones, are used equally if not more. Often mobile devices store notes, documents, images, and videos. However, it is difficult to properly mount or align a mobile device for viewing when simultaneously using a keyboard.

### BRIEF SUMMARY

An apparatus for multizone mobile electronic device holder keyboard disclosed. An apparatus for a multizone mobile electronic device at an ideal viewing angle and a method of making the apparatus are also disclosed. In one embodiment, the apparatus includes a keyboard, a first channel disposed along an upper portion of the keyboard, the first channel having a first width, and a second channel disposed along the upper portion of the keyboard, the second channel having a second width, and each of the first and second channels are configured to hold a mobile electronic device at a set viewing angle.

In some embodiments, the apparatus includes a third channel disposed along the upper portion of the keyboard and the third channel has a third width. In other embodiments, the first, second, and third channels are interconnected to form a monolithic continuous channel comprising varying widths.

In some embodiments, the set view angle of the mobile electronic device is between 60° and 70°. In some embodiments, the channel further includes ridges along at least one side wall of the channel. In other embodiments, the channel includes a rubber lining along at least one side wall of the channel.

An apparatus for multizone mobile electronic device holder at a set viewing angle includes a channel in a keyboard configured to hold the mobile electronic device at a set viewing angle and a fabricated insert disposed on a first side of the channel, wherein a gap between a second side of the channel and the fabricated insert includes a first width and a second width. In some embodiments, the channel further includes at least three regions of varying widths. In other embodiments, the channel of three regions of varying widths is monolithic. In some embodiments, the set view angle of the mobile electronic device is between 60° and 70°. In some embodiments, the channel further includes ridges along at least one side wall of the channel. In other embodiments, the channel includes a rubber lining along at least one side wall of the channel.

A method for manufacturing a keyboard includes forming a channel along a side of the computer keyboard device, the channel is configured to hold a mobile electronic device at a viewing angle, and disposing a fabricated insert on a first side of the channel to form a gap between a second side of the channel and the fabricated insert having at least two regions of different gap widths. In some embodiments, the method includes molding ridges along at least one side wall of the at least one channel to assist in holding a mobile electronic device at a viewing angle.

Reference throughout this specification to features, advantages, or similar language does not imply that all of the features and advantages that may be realized with the subject matter of the present disclosure should be or are in any single embodiment of the subject matter. Rather, language referring to the features and advantages is understood to mean that a specific feature, advantage, or characteristic described in connection with an embodiment is included in at least one embodiment of the subject matter of the present disclosure. Thus, discussion of the features and advantages, and similar language, throughout this specification may, but do not necessarily, refer to the same embodiment.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a top plan view illustrating one embodiment of a multizone mobile electronic device holder keyboard apparatus;

FIG. 2 is a side plan view of FIG. 1 illustrating one embodiment of multizone mobile electronic device holder keyboard apparatus;

FIG. 3 is an alternate side plan view of FIG. 1 illustrating one embodiment of multizone mobile electronic device holder keyboard apparatus; and

FIG. 4 is side view of an apparatus of FIG. 1 holding an electronic mobile device.

### DETAILED DESCRIPTION

Reference throughout this specification to “one embodiment,” “an embodiment,” or similar language means that a particular feature, structure, or characteristic described in connection with the embodiment is included is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, processors, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to one or more processors of a general purpose computer, special purpose computer, or other programmable data processing apparatus to produce a machine, such that the instructions, which execute via the one or more processors of the computer or other programmable data processing apparatus, create means for implementing the functions/acts specified in the schematic flowchart diagrams and/or schematic block diagrams block or blocks.

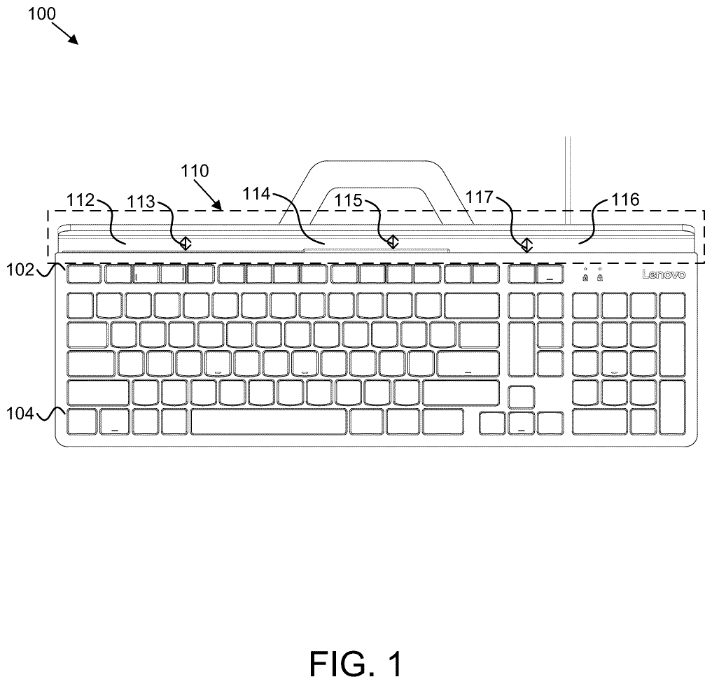

FIGS. 1-4 illustrate some embodiments of an apparatus for a multizone mobile electronic device holder keyboard 100. The keyboard 100 has an upper portion 102 and a lower portion 104. In some embodiments, the lower portion 104 includes a traditional QWERTY keyboard. In other embodiments, the lower portion 104 also includes a number keypad to one side.

In some embodiments, keyboard 100 has an upper portion 102 and along the upper portion 102 is a first channel 112 having a first width 113 and a second channel 114 disposed along the upper portion 102 of the keyboard, the second channel 114 having a second width 115, and each of the first and second channels, 112 and 114 respectively, are configured to hold a mobile electronic device at a set viewing angle 120.

In some embodiments, the first channel 112 and the second channel 114 are a singular continuous channel 110. In other embodiments, the upper portion 102 includes a third channel 116 and the third channel 116 has a third width 117. In some embodiments, the first 112, second 114, and third 116 channels are interconnected to form a monolithic continuous channel 110 comprising varying widths. In some embodiments, the first width 113 is different than the second width 115 and different than the third width 117, such that no channels have the same width.

In some embodiments, the first channel 112 has a width 113 between 11 mm and 12 mm. In some embodiments, the second channel 114 has a width 115 between 9.5 mm and 10.5 mm. In some embodiments, the third channel 116 has a width 117 between 12 mm and 13 mm.

In other embodiments, the set viewing angle 120 of the mobile electronic device 200 is between 60° and 70°. In some embodiments, the set viewing angle 120 is approximately 65°.

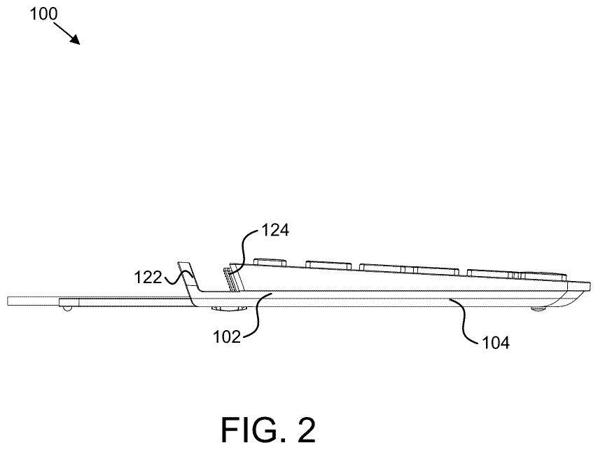

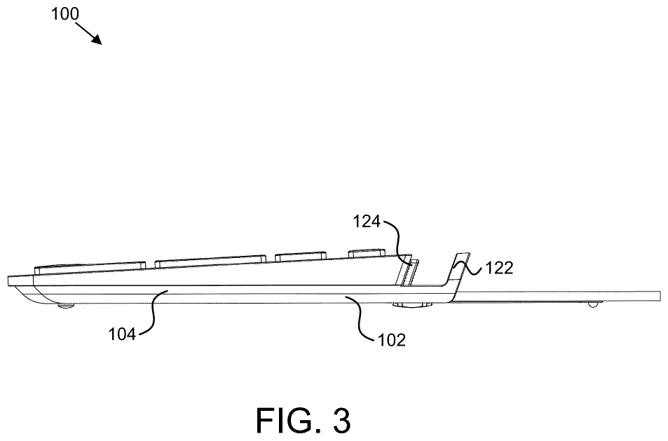

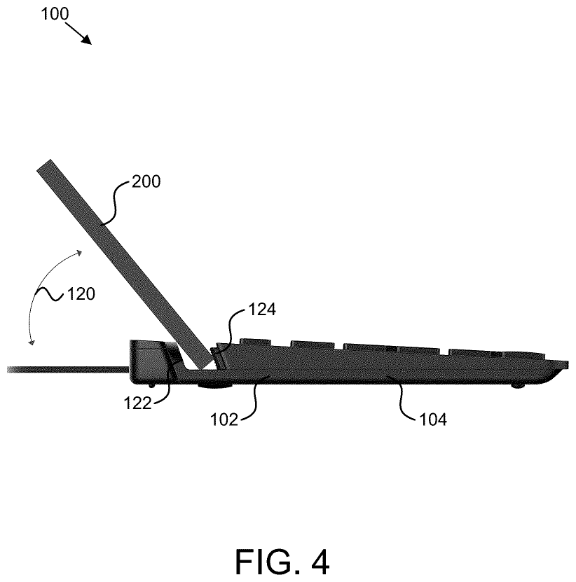

In some embodiments, the first channel 112 and the second channel 114 include ridges 124 on at least one side wall 122 of the channel, as shown in FIGS. 2 and 3. In another embodiment, the first channel 112 and second channel 114 include a rubber lining along at least one side wall of the channel. As shown in FIG. 4, the ridges 124 and/or the rubber lining assist in maintaining the proper set viewing angle 120 of the mobile electronic device 200.

An apparatus for multizone mobile electronic device holder at a set viewing angle 120 includes a channel 110 in a keyboard 100 configured to hold the mobile electronic device 200 at a set viewing angle 120 and a fabricated insert disposed on a first side of the channel, wherein a gap between a second side of the channel and the fabricated insert includes a first width 113 and a second width 115. In some embodiments, channel 110 further includes at least three regions of varying widths, e.g., a first channel 112, a second channel 114, and a third channel 116. In other embodiments, channel 110 of three regions of varying widths is monolithic in construction. In some embodiments, the set viewing angle 120 of the mobile electronic device is between 60° and 70°. In some embodiments, channel 110 further includes ridges 124 along at least one side wall 122 of the channel 110. In other embodiments, channel 110 includes a rubber lining along at least one side wall 122 of the channel 110.

A method for manufacturing a keyboard includes forming a channel 110 along a side of the computer keyboard device, the channel 110 is configured to hold a mobile electronic device 200 at a viewing angle 120, and disposing a fabricated insert on a first side of the channel 110 to form a gap between a second side of the channel and the fabricated insert having at least two regions of different gap widths, 113 and 115 respectively. In some embodiments, the method includes molding ridges 124 along at least one side wall 122 of the at least one channel 110 to assist in holding a mobile electronic device 200 at a viewing angle 120.

In the above description, certain terms may be used such as “receiving,” “inserting,” “attaching,” “connecting,” and the like. These terms are used, where applicable, to provide some clarity of relationships. But, these terms are not intended to imply absolute relations. Rather, these terms may be interchangeable with one another.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

Additionally, as used herein, “adjacent” does not necessarily denote contact. For example, one element can be adjacent another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

The subject matter of the present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a keyboard;
a first channel disposed along an upper portion of the keyboard, the first channel having a first width configured to hold a mobile electronic device at a first set viewing angle;
a second channel disposed along the upper portion of the keyboard, the second channel having a second width, wherein the second width is different from the first width and the second width configured to hold the electronic device at a second set view angle which is different from the first set viewing angle; and
the first set viewing angle and the second set viewing angle of the electronic device are between 60° and 70°.

2. The apparatus of claim 1, further comprising a third channel disposed along the upper portion of the keyboard, the third channel having a third width wherein the third width is different from the first width and the second width.

3. The apparatus of claim 2, wherein the first channel, the second channel, and the third channel are interconnected to form a monolithic continuous channel comprising the first width, the second width, and the third width respectively.

4. The apparatus of claim 2, wherein the first width is between 11 mm and 12 mm.

5. The apparatus of claim 2, wherein the second width is between 9.5 mm and 10.5 mm.

6. The apparatus of claim 2, wherein the third width is between 12 mm and 13 mm.

7. The apparatus of claim 1, wherein the first set viewing angle of the mobile electronic device is 65°.

8. The apparatus of claim 1, wherein at least one channel further comprises ridges on at least one side wall of the channel.

9. The apparatus of claim 1, wherein at least one channel of the first channel and the second channel comprises a rubber lining along at least one side wall of the at least one channel.

10. An apparatus comprising:
a channel in a keyboard configured to hold a mobile electronic device, the channel comprising a first region having a first width and a first set viewing angle for the mobile electronic device and a second region having a second width and a second set viewing angle for the mobile electronic device, wherein the second width is different from the first width and the first viewing angle is different from the second viewing angle; and
a fabricated insert disposed on a first side of the channel, wherein a gap between a second side of the channel and the fabricated insert comprises a first width and a second width.

11. The apparatus of claim 10, wherein the at least one channel further comprises a third region having a third width, wherein the third width is different from the first width and the second width.

12. The apparatus of claim 11, wherein the at least one channel comprising at least three regions of varying widths is monolithic.

13. The apparatus of claim 10, wherein the first set viewing angle and the second set viewing angle of the mobile electronic device are between 60° and 70°.

14. The apparatus of claim 10, wherein the at least one channel further comprises ridges on at least one side wall of the channel.

15. The apparatus of claim 10, wherein the at least one channel further comprises a rubber along at least one side wall of the channel.

16. A method of manufacturing a keyboard comprising:
forming a channel along a side of the computer keyboard device; and
disposing a fabricated insert on a first side of the channel to form a gap between a second side of the channel and the fabricated insert comprising a first region having a first width configured to hold a mobile electronic device at a first set viewing angle and a second region having a second width configured to hold the mobile electronic device at a second set viewing angle, wherein the second width is different from the first width.

17. The method of claim 16, the method further comprises molding ridges along at least one side wall of at least one region of the fabricated insert to assist in holding a mobile electronic device at the first viewing angle and the second viewing angle.
